(19) United States
(12) Patent Application Publication
(10) Pub. No.: US 2009/0138880 A1
(43) Pub. Date: May 28, 2009

(54) Method for organizing a multi-processor computer

(76) Inventor: Andrei Igorevich Yafimau, Obninsk (RU)

Correspondence Address: Aleksandr Smushkovich, POB 140505, Brooklyn, NY, 11214, US

(21) Appl. No.: 11/991,331

(22) PCT Filed: Apr. 26, 2006
(86) PCT No.: PCT/RU2006/000209

§ 371 Date: Feb. 29, 2008

(30) Foreign Application Priority Data
Sep. 22, 2005 (RU) 2005129301

(51) Int. Cl. G06F 9/46; G06F 11/30

(52) U.S. Cl. 718/103; 718/100; 712/205; 712/220

(57) ABSTRACT

The invention relates to computer engineering and can be used for developing new-architecture multiprocessor multithreaded computers. The aim of the invention is to produce a novel method for organizing a computer, devoid of the disadvantageous feature of existing multithreaded computers, i.e., overhead costs due to the reload of thread descriptors. The inventive method encompasses using a distributed presentation which does not require loading the thread descriptors in the computer multi-level virtual memory, whereby providing, together with current synchronizing hardware, the uniform representation of all independent activities in the form of threads, the multi-program control of which is associated with a priority pull-down with an accuracy of individual instructions and is totally carried out by means of hardware.

### CROSS-REFERENCE TO RELATED APPLICATIONS

This application is a U.S. national phase application of a PCT application PCT/RU2006/000209 filed on 26 Apr. 2006, published as WO2007/035126, whose disclosure is incorporated herein in its entirety by reference, which PCT application claims priority of a Russian patent application RU2005/129301 filed on 22 Sep. 2005.

### FIELD OF THE INVENTION

The invention relates to the field of computer engineering and can be used for developing new-architecture multiprocessor multithreaded computers. The aim of the invention is developing of a novel method for organizing a computer, devoid of the main disadvantageous feature of the existing multithreaded processors, i.e., overhead costs due to the thread descriptors reloading, wherein a set of executing threads is changing, and improving the computer performance/cost ratio on this basis.

### BACKGROUND OF THE INVENTION

In the mid-sixties, multithreaded architecture was originally used to reduce the amount of equipment by providing correspondence of the fast-operating logic with the slow ferrite-based memory in the peripheral computers of the CDC6600 supercomputer [Ref-4]. The peripheral computer was built in the form of single control and executive units, which were connected to a single block of registers from a cluster of such blocks in a multiplexing mode forming a virtual processor in any selected time interval. In the modem terminology [Ref-5], the aggregate of such virtual processors behaves as a multithreaded computer executing the set of threads represented by the descriptors loaded into all blocks of the registers.

Subsequently, as the electronics and integrated circuit density have increased with a simultaneous decrease of their cost, multi-syllable pipelined parallel processors have become widely usable. In such processors, a few various type instructions-syllables can be submitted to the entrance of an executive units pipe by a fetching unit during a single machine clock interval. As a result, in the processor, at various stages of execution (the number of which depends on the depth of the pipe), in several executive devices of different types (the number of which is determined by the width of the pipe), there can be a large number of concurrently executed instructions. However, instructions information dependencies, inherently appropriate to a single flow, lead to periodical inactivity of the pipe, thus an increase of the pipe's depth and width becomes inefficient for acceleration of calculations.

This problem has been solved in multithreaded processors [see appended Ref-5], in which a fetching unit, in each machine clock interval, can fetch the instructions of various independent threads and send them to the entrance of an executing pipe. For example, in supercomputer Tera [Ref-5] developed in 1990, an executing pipe with a width of 3 and a depth of 70 is used, and its executing unit works with 128 threads, wherein about 70 threads provide full loading of the executing pipe.

Inside the operating system, a thread, being in a running state or a waiting state, is represented by its descriptor, uniquely identifying the thread and its executing or processing context. The process is a system object, to which an individual address space is allocated, which space is also called a ‘process context’. The root of representation of an active processes context is placed in hardware registers of a virtual memory control unit of the executing processor.

A thread representation that allows to pause and resume running a thread in the context of an owner-process is called a virtual processor [Refs-2,3,5]. The control of a multi-program mix by the operating system, in general terms [Ref-2], boils down to the creation and termination of processes and threads, the loading of activated virtual processors into the hardware registers and the unloading of virtual processors into memory, if the virtual processors are transitioned for any reason into the state of waiting. Independent sequential activities-threads are run in the process context, wherein the virtual memory mechanism provides protection against uncontrolled mutual impact of threads of different processes.

In accordance with the classical Dijkstra's [Ref-1] work describing the essence of interaction of sequential processes, threads are fundamental elements, and any parallel computing is built based on their synchronized executions. A multitude of sequential independent activities are formed in any computer for the following reasons:—explicit establishing a thread by the operating system, herein called ‘explicit threads’;—a launch of processing an asynchronous signal issued by software, herein called ‘signal threads’;—a launch of processing an asynchronously produced hardware interrupt, herein called ‘interrupt threads’.

These activities, herein collectively called ‘an entire plurality of threads’, represented by threads of any form in the operating systems, may be either in a running state, or in a state of waiting for an event causing activation. Apparently, the allowable multitude of threads' descriptors uploaded into the registers in all known multithreaded computers is significantly less then the whole possible multitude of threads. Thusly, for the resumption of execution of a suspended thread, it is necessary to unload the entire thread descriptor representation of another thread from the hardware processor registers into the memory, and to upload the activated thread descriptor in the reverse order.

For example, a thread descriptor in the mentioned multithreaded computer Tera [Ref-5] consists of 41 words of 64 bits long, and the time of a simple reloading is comparable with the interrupt handling time. If a complicated transition occurs switching to a thread of another protection domain (running in another process context), an additional reloading of virtual memory tables, representing the domain, takes place. Clearly, such reloadings are major overheads, hindering the use of powerful multithreaded processors in large database management systems, in large embedded systems, and other important areas, in which running programs create a lot of frequently switching processes and threads.

One of the definitions further used in the present disclosure is ‘architectural instructions’ or ISA. An instruction set architecture (ISA), or a total instruction set, or just ‘architecture’, herein means part of the computer architecture related to programming, including native data types, instructions (herein called architectural instructions), registers, addressing modes, memory architecture, interrupt and exception handling, and external I/O. The ISA includes the specification of a set of opcodes (machine language), and native commands implemented by a particular CPU design. The ISA is distinguished from the micro-architecture, which is a set of processor design techniques used to implement the ISA. Computers with different micro-architectures can share a common instruction set. For example, the Intel Pentium and the AMD Athlon implement nearly identical versions of the x86 instruction set, but have radically different internal designs. There is some inverse analogy between the conception of ISA and a conception of transaction, used below. Transactions represent processor design techniques for uniformly performing a plurality of ISAs in a fixed set of executing clusters, described below.

### BRIEF DESCRIPTION OF THE INVENTION

The aforesaid type of descriptors has a representation that may be essentially defined as a ‘concentrated’ descriptor representation in micro-architecture of a computer. The concentrated descriptor representation is characterized as follows: a1) in order to perform threads' instructions by a processor's logics it is uploaded into the micro-architectural registers (herein also called micro-architectural operating registers) as a whole, which registers are the upper and fastest-access level in the hierarchy of the multi-level computer memory; b1) upon transition of a thread from the active state into the waiting state, its concentrated descriptor representation is re-written from the micro-architectural registers into a lower virtual memory level, typically into the cache of first level; c1) a reloading of such concentrated representation of another thread into the micro-architectural registers in the reverse direction (so called ‘swapping’) is carried out by a piece of software executed on the processor for which the swapping is performed. In the known types of computer architecture, the descriptors of this type are rewritten between memory levels in the concentrated form, and always programmably.

In contrast, the present invention introduces a new type of descriptor representation, herein called a ‘distributed descriptor representation’ or a ‘distributed descriptor means’ that is characterized as follows: a2) the creation of new threads and an initial uploading of their descriptor representations into the operating micro-architectural registers is accomplished by the operating system; b2) thereafter, portions of the descriptor representations of all created threads (the entire plurality of computer's threads), in both the active and waiting states, can be distributed either in the operating micro-architectural registers or in the lower levels of the virtual memory; c2) at the moment of execution of a command issued by any of the created threads, the processor units provide a pure direct hardware uploading (without software support) of required by the command portions of the distributed descriptor representation from a lower virtual memory level typically from the cache of the first level into the processor's operating micro-architectural registers. It should be noted, that the operating micro-architectural registers and the cache memory of the first level are typically incorporated in a common high-density integrated microchip, and thus the distribution is logical rather than physical.

Distinctly from the prior art's concentrated descriptors, in the proposed invention, the executing thread's descriptor representation is distributed throughout memory levels. Its parts can be apportioned at different memory levels, and these parts can be rewritten between the levels exclusively by the hardware means according to the dynamics of thread transitions between the active and waiting states. Briefly, the terms ‘concentrated’ and ‘distributed’ are used to correspond to the manner of the thread descriptor movements between the memory of the micro-architectural registers and the virtual memory: either as a whole, or by portions. In this invention, the hardware means provide a multiprogramming precision determined by one command, i.e. enable redistribution of micro-architectural resources from a lower priority thread to a high priority thread upon each command, whereas in the traditional multiprocessor computers such redistribution occurs only after execution of thousands commands.

The essence of the present invention can be determined as follows: instead of using the well-known concentrated representations of virtual processors, requiring the reloading of a set of the physical processor's registers, also called ‘micro-architectural’ registers, for executing threads in an owner-process' virtual memory, it is proposed the new distributed representation of thread descriptors, not requiring such reloading, stored in the computer system virtual memory, which new descriptor, in conjunction with new hardware synchronization means requiring no software support, provides a uniform representation of all independent sequential activities (i.e. the entire plurality of threads in the computer), related to threads produced by—the operating system, or—programmably assigned by handlers of asynchronously issued software signals, or—produced by hardware interruptions, and thereby allows eliminating the need in software implemented multiprogramming with a priority pull-down, since it's carried out totally by means of hardware.

### DETAILED DESCRIPTION OF THE INVENTION

Based on the aforesaid, a new method for organization of a multiprocessor computer is proposed, which method encompasses an arrangement of at least one thread monitor, at least one functional executing cluster, and at least one virtual memory management unit supporting inter-process context protection, all interacting across a broadband packed-switching network that supports prioritized exchange.

The aforesaid virtual memory management unit implements well-known functions for storage of programs and processes' data, and differs in that it simultaneously supports the system virtual memory that is common for all processes, which system virtual memory provides storing and fetching elements of distributed representation descriptors of threads.

Each aforesaid thread monitor comprises an architectural instruction fetching unit, a primary cache of data, a primary cache of architectural instructions, and a register file of tread queues. The architectural instruction fetching unit is capable to issue a number (at least one) of instructions. This at least one instruction (or these instructions) can be a single instruction or a set of instructions. It can be represented in the form of a number of (at least one) transactions.

The monitor reflects specifics of the flow of executing architectural instructions. In the other words, a monitor of a certain type ultimately corresponds to a predetermined type of architectural instructions. The architecture and the number of monitors are chosen in accordance with the main purpose of a particular computer. Using the plurality of monitors is very important for widespread use of the proposed method. The plurality of monitors provide for wide scalability of computers based on them. Different monitor architectures provide for creation of advanced computers with essentially fill compatibility for system and application software, which have been used for existing computers.

Any distributed descriptor includes a root. The root of the thread's distributed descriptor representation is placed in an element of the primary cache of data. The root includes a thread identifier, global for the computer, which identifier defines—the thread's pertinence (correspondence) to the context of the process;—a global priority totally defining the order of service of the thread by any monitor;—an execution order of thread-issued instructions in the executing clusters and in the memory management unit;—the order of packet transmission over the network;—the replacement order of elements of the descriptor representation between all levels of cache memory, partially in combination with known methods of reference frequency estimation; and—a portion of the architectural registers' representation, which portion is necessary and sufficient for primary fetching the mentioned above architectural instructions and formation of transactions therefrom.

In accordance with priority, the aforesaid architectural instruction fetching unit fetches the next thread descriptor from a resident ready-to-run threads queue, and, based on the current instruction pointer and, utilizing the well-known super-scalar or the very large instruction word (VLIW) method, performs primary fetching the architectural commands and forming on their basis transactions of a form, common for all monitors types, which transactions contain instructions and an information dependencies graph describing a partial order of their execution. In the simplest form, a transaction reduces to a single instruction. With an intention to speed up running a single thread, one can use a more sophisticated form of transaction fully adequate to the aforesaid super-scalar or VLIW approach. Herein, a ‘secondary instruction’ term is used as a synonym for ‘transaction’. If the transaction contains more than one instruction, it contains information on the order of executing these instructions and the information dependencies graph.

Single thread transactions are issued by the architectural instruction fetching units of monitors to the executing clusters strictly sequentially: next transaction is issued upon receipt of a result of the previous one from the executing cluster. During the waiting-for-result time, the thread descriptor is transitioned over into the waiting state in the resident queue. A separate transaction begins and ends in the same cluster, and various transactions may begin and end in different clusters.

The executing cluster comprises a sequencer; a set of functional execution units; a local register file of queues for placement transactions; a load-store unit; and a primary data cache, wherein portions of distributed thread descriptor representation are placed, which portions correspond to the instructions carried out in the cluster. The number and architecture of the executing clusters are determined by a set of monitors deployed.

For clarity of explanation, with intention of reducing the bulk of hardware one can use the same set of clusters (or a single cluster) for executing secondary instructions (transactions) issued by a plurality (at least two) of monitors of different architectures with corresponding types of architectural instructions. For instance, in a computer, one powerful mathematical calculation cluster with one sophisticated functional dividing unit can be used, which will execute relatively rare division instructions issued by the plurality of monitors served by the cluster.

The aforesaid sequencer accepts transactions from the network, rewrites their instructions and the information dependencies graph into the cluster register file, rewrites ready-to-run instructions into priority-ordered secondary-fetching resident queues, performs the secondary fetching, and passes the ready-to-run instructions with prepared operands to the entrances of the aforementioned functional execution units of the cluster. The functional execution units carry out incoming instructions with the operands, prepared during the secondary fetching, and issue a result of completion to the sequencer. The sequencer corrects the information dependency graph, according to the result of completion, and, as a result of the correction, it either rewrites the resultant ready-to-run instruction into the secondary fetching queue, or passes the transaction completion result to the originating monitor, which monitor moves the corresponding thread into the ready-to-run queue while performing a correction of the thread's representation root.

Information between computer units is transmitted over the network in the form of packets, in which the functional data are supplemented with headers containing the priority, the source address, and the destination address.

According to the invention, the method, used to represent the waiting state of a thread through storing its descriptor in the hardware-supported resident waiting-for-transaction-completion queue in the thread monitor, and storing instructions, waiting for their operands, in the sequencer resident queues, is also applied for the representation of waiting for entering a critical interval (or a critical section) at a semaphore and for the representation of an emerging program-issued event as follows further.

The mentioned classical work of Dijkstra [Ref-1], describing the essence of interaction of sequential processes (such as threads), introduces the foregoing terms of ‘critical interval’ and ‘semaphore’. The semaphore, in computer science, is a protected variable (or of the abstract data type), which employs a classic method for synchronization in a multiprogramming environment. Semaphores exist in many variants, and in this invention are represented as a special hardware implemented feature (herein also called ‘semaphore synchronization means’) with the semantics described herein below. The critical interval can be compared to a railroad section that can pass only one train at a time at a signal of the semaphore. There cannot be two trains moving at the same time through the section. Similarly, a certain section of program code (its critical interval, e.g. keyboard entering code) must not be executed simultaneously in more than one thread. The change of semaphore's signal to ‘green’ is the event related (or affiliated) with the critical interval.

Also, in existing architectures, cache memory is used by the central processing unit (CPU) to reduce the average time to access the memory. The cache is a smaller and faster memory, which stores copies of data from the most frequently used main memory locations. Typically, two levels of cache memory (primary and secondary) are used. The primary cache is built in a processor's chip and provides fastest data access, but has a small cache memory size. The secondary cache provides slower data access, but a larger cache memory size. On the hardware level, the cache comprises a cache controller, which provides interaction with the CPU, and cache memory for storage of data. The controller of the secondary cache is herein called a ‘secondary cache controller’. In this invention the secondary cache controller is imparted with a new functionality: it implements hardware semaphores and synchronization instruction described below.

The synchronization instructions, being used to enter the critical interval and waiting for the events, are considered as waiting for readiness of their operand-semaphore. Analysis of readiness of the operand and notification of the causes of readiness are implemented as a set of distributed actions, performed by the sequencer and the load-store unit of the executing clusters, and, on the other hand, by the secondary cache controller of the virtual memory management unit, which is indivisible from the viewpoint of changing the state of the threads that perform the synchronization instructions.

A set of synchronization instructions (herein also called ‘synchronization instruction means’) consists of five commands working with a semaphore-operand, placed in virtual memory blocks, cached only in the secondary cache of the computer memory management unit. A first command creates a semaphore-variable with two initialized empty-value fields and, as a result, returns the address of this variable, further used in the remaining synchronization instructions as a ‘semaphore-operand’.

In the course of operation, the pointers of the waiting queues, placed in the secondary cache controller and ordered by priority and arrival order, are placed in the fields of semaphore variable. The identifiers of the threads, waiting for the given semaphore to enter the critical interval, are stored in a first queue pointed by the first field of semaphore, wherein the head of the queue contains an identifier of the only thread located in the critical interval. The identifiers of the treads waiting for an event affiliated with the critical interval, are stored in a second queue pointed by the second field of semaphore.

A second command with a first operand (the semaphore-operand) and a second operand (a timeout-operand) is used to introduce the thread into the critical interval, when the semaphore's first field value is empty; or to move the thread into the waiting state when the semaphore's first field value is nonempty, by placing the thread in the queue pointed by the semaphore's first field value. In this command the timeout-operand sets the limit duration of the waiting state until the first field of semaphore will be free and the thread will be able to enter the corresponding critical interval.

A third command with the semaphore-operand instructs the thread to exit the critical interval, removing the identifier of already executed thread from the head of the semaphore's first field related queue. If the so-corrected queue is still nonempty, the third command instructs the thread, identified by the first element of the queue, to enter the critical section.

A fourth command is performed inside the critical interval with the intention of waiting for either an event, affiliated with the critical interval or triggered by the ending of the second timeout, while the command is moved into the waiting state in the queue identified by the semaphore's second field, and the critical interval is cleared by removing the identifier of already executed thread from the head of the semaphore's first field related queue. If the so-corrected queue is still nonempty, the command instructs the thread, identified by the first element of the queue, to enter the critical section. The time-out operand in this command is analogous to the one described for the second command.

A fifth command with a single semaphore-operand is executed ensuring the thread to exit from the critical interval with notification about this event. Thus, it is established that if the second field related waiting queue is nonempty, the first thread from this queue is entered into the critical interval; or if such a thread is absent, then either the first thread from the first field related queue is entered into the critical interval, or if the first field related queue is empty, the critical interval is freed.

Where the second and fourth commands are completed due to time-out, the already executed thread is not entered into the critical interval, but its identifier is simply removed from the waiting queue. In both cases, the cause for the time-out completion or on an event occurrence is made available for analysis as a program-accessible result.

It should be noted that in the proposed method of organizing a multiprocessor computer, a uniform representation at the hardware level is achieved in all situations related to the waiting of operands preparedness due to information dependencies of the instructions flow, the execution of long-lasting floating-point instructions, accesses to the operands in a multilevel virtual memory, as well as waiting periods, inherent to parallel programs because of the need in synchronizing, and a purely hardware implementation of the transfer of the thread from the active state into the waiting state, and vice-versa.

Therefore, in a computer, organized according to the proposed method, the known program control of a multiprogramming mix, with a priority pull-down and with an accuracy of individual instructions, is automatically accomplished completely by hardware in combination with the global priorities of threads, which priorities are inherited by the commands and by the packets transmitted over the network.

In addition, due to the storing of the distributed representation of thread descriptors uniformly with the storing of program code and data in multi-level virtual memory, providing the swapping of long-time unused elements from the primary caches of the thread monitor and executing clusters by means of conventional virtual memory techniques, it becomes possible to implement pure hardware support of a very large number of processes and threads corresponding to the total number of processes and threads created in a system, as well as support of potential sequential independent activities, which are asynchronously launched as handlers of program signals and hardware interrupts.

The closest prior art method to the proposed invention is the method for organizing a computer described in Belarus Patent No. 5350 [Ref-3]. That patent discloses a concentrated thread descriptor representation, in the form of vector program-accessible registers placed in the common memory management unit and used to increase a fixed-size working set of virtual processors, corresponding to threads, in terms of this invention. In the instant inventive method, such a descriptor is placed in the special system virtual memory and is distributed in cache elements of monitors and executing clusters.

Due to the use of swapping out the elements of thread descriptors representation as conventional virtual memory blocks, the improvement allows increasing the number of simultaneously running threads on any computer, without a software reloading of the hardware registers up to the total number of existing and potential independent activities. This feature, in combination with the described-above hardware synchronization means for crossing the critical interval, with the means for events waiting and signaling (which means are all absent in the prior-art patent) allows implementing complete hardware multiprogramming with prioritized pull-down with granularity at a level of single instruction. All these measures lead to a significant increase of productivity and cost efficiency of a multithreading computer.

All units implementing the described herein inventive method can be built on the basis of typical standard elements of the modem digital circuit technology: cache controllers of different levels, main memory (RAM) modules for the memory management unit and for highly-density programmable logic. Implementation of the monitor is not essentially different from that of the instruction-fetching units of existing multithreaded processors. The transaction's form can be used as described in Belarus Patent No. 5350 [Ref-3]. Execution devices of the clusters are not different from the known execution units. The sequencers are implemented with quite simple algorithms to handle descriptors movements among queues and their development can be routinely accomplished by a person with ordinary skills in the art.

Distributed handling of the synchronization instructions is slightly more difficult than implementation of known synchronization instructions, but can also be routinely developed by a person skilled in the art. The mentioned broadband packets-transmission network, implementing a parallel multi-channel exchange, can be built similarly to the one utilized in conventional multithreaded computers [Ref-5]. According to the stated above, it is possible to draw a conclusion on the feasibility of the method proposed in the invention.

As mentioned earlier in the description, the purpose of the invention constitutes a development of a novel method of organizing a computer, free from the main shortcoming of the existing multithreaded processors, i.e. overhead costs caused by thread descriptors reloading when changing the set of executing threads, and, on this basis, improvement of the computer's performance/cost ratio. As disclosed herein above, this purpose has been achieved in the proposed invention.

While the invention may be susceptible to embodiment in different forms, there are described in detail hereinabove, specific exemplary embodiments of the present invention, with the understanding that the present disclosure is to be considered an exemplification of the principles of the invention, and is not intended to limit the invention to that as illustrated and described herein.

### REFERENCES

Ref-1. Dijkstra E, Cooperating sequential process//Programming languages, M.: Mir, 1972 p. 9-96, Russian translation from E.-W. Dijkstra, Cooperating sequential process, In F. Genuys, editor, Programming Languages. Academic Press, New York, 1968.

Ref-2. Deitel H. An introduction to operating systems: In 2 v. V. 1. M.: Mir, 1987 359 p, Russian translation from An introduction to operating systems. Harvey M. Deitel. Addison-Wesley, 1985.

Ref-3. Yafimau, A. I. Method for organizing a multi-processor computer. The description of the patent of Republic of Belarus N 5350.

Ref-4. Ph. Enslow, Multiprocessor Systems and Parallel Computing, M.: Mir, 1976-384 p Russian translation from P. H. Enslow. Multiprocessors and Parallel Processing. New York: John. Wiley. 1974.

Ref-5. Robert Alverson, David Callahan, Daniel Cummings, Brian Koblenz, Allan Porterfield, Burton Smith (1990). The Tera Computer System. In Proc. Int. Conf. Supercomputing, Amsterdam, The Netherland, 1990, June, pp. 1-6.

1. A method of organizing a multiprocessor computer comprising the steps of:
providing an operating system, said operating system capable of establishing a plurality of processes; an entire plurality of threads within said plurality of processes, said entire plurality of threads consisting of explicit threads, signal threads and interrupt threads; each thread of said entire plurality of threads represented by a descriptor inside the operating system; and a plurality of process contexts associated with said processes, each said context providing the running of at least one thread from said entire plurality of threads;
providing hardware means, associated with said operating system, and capable of issuing asynchronous hardware interrupts causing activation of said interrupt threads;
providing software means associated with said operating system, and capable of issuing asynchronous signals causing activation of said signal threads;
providing system virtual memory, associated with said hardware means and said operating system, said system virtual memory comprising a number of memory levels;
said hardware means including:
a plurality of processor units each containing registers, and
at least one virtual memory management means supporting at least said system virtual memory;
wherein the improvement characterized in that
said hardware means further including:
at least one thread monitor comprising
an architectural instruction fetching means capable of issuing at least one instruction,
a register file means, and
a primary data cache means;
at least one functional executing cluster comprising
a sequencer means capable of accepting said at least one instruction.
a functional execution means,
a local queues register means, and
a load-store means;
said virtual memory partially allocated to said at least one functional executing cluster, and to said at least one thread monitor;
a broadband packet-switching network supporting prioritized exchange and interactions at least between: said at least one virtual memory management means, said at least one functional executing cluster, and said at least one thread monitor; semaphore synchronization means associated with synchronization instruction means; said synchronization instruction means associated with at least said at least one virtual memory management means, said sequencer means, and said load-store means;
wherein
said at least one virtual memory management means configured to simultaneously support all said processes and protection against uncontrolled mutual impact of said threads of different said processes; and
said descriptor configured in the form of distributed descriptor means, predetermined portions of said distributed descriptor means capable of being stored in and fetched from said registers and said system virtual memory; and said distributed descriptor means capable of relocation between the processor registers and said memory levels by means of said hardware means, and according to said semaphore synchronization means and said synchronization instruction means.

2. The method of claim 1 wherein said at least one instruction issued as a number of transactions.

3. The method of claim 2, wherein said number of transactions comprising at least two instructions, capable to contain information about the order of executing said at least two instructions.

4. The method of claim 2, wherein said at least one thread monitor comprising at least two thread monitors, said at least one functional executing cluster consisting of a single functional executing cluster, capable of performing said number of transactions issued by said at least two thread monitors.

5. The method of claim 1, wherein said at least one thread monitor comprising at least two thread monitors, and said at least two thread monitors each corresponding to a predetermined type of architectural instructions.
